(19) United States
(12) Patent Application Publication
(10) Pub. No.: US 2005/0280256 A1
(43) Pub. Date: Dec. 22, 2005

(54) Corner bookmark

(76) Inventor: Lorenzo Porcelli, Ossining, NY (US)

Correspondence Address: COLLEN IP, THE HOLYOKE MANHATTAN BUILDING, 80 SOUTH HIGHLAND AVENUE, OSSINING, NY, 10562, US

(21) Appl. No.: 11/154,756

(22) Filed: Jun. 16, 2005

Related U.S. Application Data
(60) Provisional application No. 60/580,226, filed on Jun. 16, 2004.

(51) Int. Cl. B42D 1/00

(52) U.S. Cl. 281/20

(57) ABSTRACT

A corner mark device that engages the top corner of a page of a book, like a sheath, and functions as a place marker. A right angle triangular construction creates a pocket corresponding in form to a page corner into which is inserted the top corner of either a right or left hand page. The device is clutched and engaged by the corner and remains until manually removed. The natural tendency of materials, like paper, to flex facilitates the ease of insertion of the page corner and the top and bottom layers are offset to make the pocket opening easily accepting of the page corner. It is non-handed and identifies the exact last page read by the user. It does not protrude and is not subject to becoming bent, worn or damaged and has appropriate dimension to permit finger-indexing to locate the saved page without visual inspection.

### CROSS REFERENCE TO RELATED APPLICATION

This application claims the benefit of U.S. Provisional Application No. 60/580,226, filed Jun. 16, 2004.

### BACKGROUND OF INVENTION

1. Field of Invention

This invention relates generally to place marking devices, known commonly as bookmarks, to allow the reader of books, periodicals, folios and other printed and non-printed matter to identify the last page read or a page to be noted at a future date and thereby marking one's place in the progress of reading multiple page printed or non-printed matter. The device for this purpose as envisioned in the invention is fitted on the top corner of the page like a sheath and functions as a compact, tactile-sensitive marker that is a duplicate in form of the page corner itself and remains engaged by both the geometry of the design and simple paper friction of page corner to the inside of the corner mark and remains such until manually removed by the user.

2. Status of Prior Art

To mark one's place in a book it is customary to use a rectangular strip of paper, leather or other material for the purpose of physically and visually indicating one's place in a book. When available, a conventional bookmark is a satisfactory place marking device. However, there are many situations when the bookmark becomes buried in the book and is not at all visible or in the other extreme it is so extended and so visible as to be unsightly and becomes prone to the bending, wear or damage of the bookmark material or in the most extreme cases, it slips out of the book when the pressure is eased on the bookmark because the book is opened. Thus while it is desirable after reading the last page to want to mark that page, no ideal device exists to allow alignment within the natural boundary and design of the page itself.

In the Igeta U.S. Pat. No. 5,237,956, two belt shaped holding parts are used for the purpose of fitting and fixing the body of the bookmark on the page, the body being described in form as rectangular. The two belt shaped bands of the holding parts hold the upper and side end of the corner of the page and the part called the body of the bookmark, but it does not provide for a means for the two thin sheets to be kept apart at a uniform dimension. The spacing and the consistency of the spacing between the two thin sheets, so necessary for a proper grip on the corner of the page, is not provided nor does it accommodate pages of differing thickness.

### SUMMARY OF INVENTION

In view of the foregoing, the main object of the invention is to provide a bookmark into which is inserted the top corner of the page of the book whereby it functions in form as a duplicate of that corner, in a compact manner and at the same time provides sufficient peripheral dimension as to allow the user to do finger-indexing to identify and open the book to the page saved in this manner even without acute visual inspection.

More particularly, an object of the invention is to provide a device for engaging the top corner of a page adapted so that a portion of the corner of the page can be easily inserted between the top and bottom layers of device made accessible by both the natural bow of the material and the displacement, or offset, of the edge of the top and bottom layers of material. The bottom layer protrudes by a measured degree further than the top layer thereby permitting the ease of insertion of the portion of the top corner of the page. A significant advantage of the invention is this offset at the opening of the pocket of the top and bottom layers which provides both physical and visual for the top corner of the page to be inserted. Regardless of whether the device is used on the top corners of the right hand or left hand page, with the respect to any graphic treatment on the device, the device always presents those graphic treatments in an upright manner.

Also an object of the invention is to provide a compact device for marking pages so that no material is appreciably external to the page thereby avoiding any bending, wear or damage to the device,

Another object of the invention is to provide adequate dimension at the periphery of the corner mark so as to be a sensual determining of the location of the corner mark thereby permitting a finger-indexing feature without the necessity of acute visual inspection.

Another object of the invention, in one embodiment, is to provide for the simple and practical construction of the corner mark with a single sheet of material whose panels are integral and contiguous and whose assembly is accomplished in the simplest of adhering techniques.

Another object of the invention is to create a pocket in this construction that can accommodate different thickness of pages in books, periodicals, folios and print and non-printed matter. The inner surfaces of this pocket may be treated in such a way as to enhance its ability to be engaged by the corner of the page.

Briefly stated, these objectives are attained in a device with a pocket into which is inserted a portion of the top corner of the page and remains engaged by the corner of the page until manually removed by the user thereby affecting a compact, finger-indexing, non-handed place marker for the reader and user of books, periodicals, folios and other printed and non-printed matter.

The device includes, in one embodiment, a triangular form based on an isosceles triangle with the leading edges of the pocket being offset to facilitate the insertion of an appropriate portion of the top corner of a page to be marked for reference for a later time or for any indication of particular note. It is formed and dimensioned to cover mainly, and conform to, the upper corner of the page to be identified for saving and therefore in one embodiment, can duplicate the exact boundary of the corner of the page of a book.

In one preferred embodiment of the device the leading edge of the bottom layer exceeds that of the leading edge of the top layer to define both visual and physical opening of the pocket contained therein to facilitate insertion of a portion of the upper corner of the page to be designated for future referral.

Another object of the invention is to provide for a front and rear panel that can be imprinted prominently and economically with advertising, promotional and descriptive messages that will always appear in an upright reading format since the corner mark is non-handed and can be used on both the right hand page and the left hand page.

### BRIEF DESCRIPTION OF DRAWINGS

For a better understanding of the invention, as well as further features thereof, reference is made to the detailed description thereof to be read in connection with the annexed drawings wherein:

FIG. 1 is a front view of an corner mark device fully assembled in accordance with the invention;

FIG. 2 is a plan view of the corner mark represented as a flat blank of material prior to assembling;

FIG. 3 is a view of the corner mark device fully assembled and engaged on the top corner of a right hand page;

FIG. 4 is a view of the corner mark device fully assembled and engaged on the top corner of a left hand page.

### DESCRIPTION OF INVENTION

The Corner Mark:

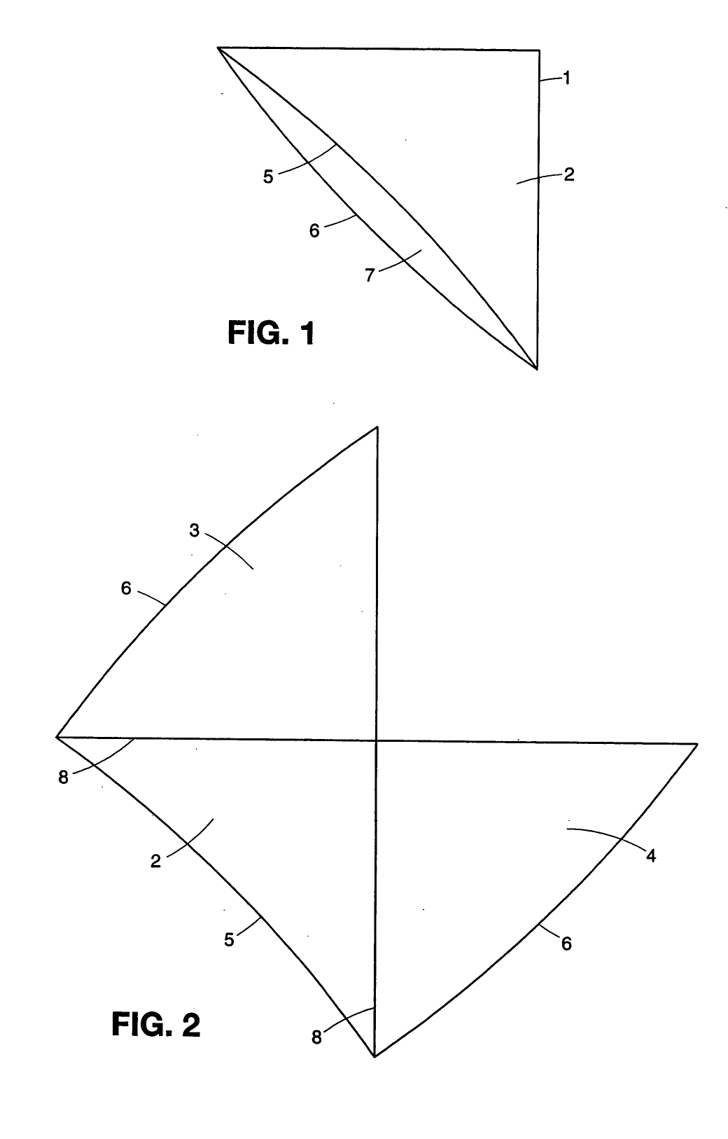

Referring now to FIGS. 1 to 4, illustrated in these figures is a corner mark device in accordance with the invention. The corner mark, in this embodiment, is triangular-shaped so that it may be attached to and conform to the top corner of a page of a book, periodical, folio or other printed and non-printed matter. The dimensions of the corner mark are such that it will engage the top corner of a page and remain in place until manually removed. The corner mark is therefore effectively a duplicate in form of the top corner of the page.

Corner mark 1 is constituted by a front panel 2, congruent and contiguous to a rear panel 3 and congruent and contiguous to an adhesive panel 4 onto which has been coated a film of adhesive and is fabricated of natural or synthetic sheet material which has been die-cut and scored. In assembly, the rear panel 3 overlaps and is bonded with the top surface of panel 4, the adhesive panel, and with their geometries congruent and coinciding they share a common lead edge 6. This lead edge 6 is part of the bottom layer and of the rear panel of the assembled corner mark.

In practice, another embodiment of this invention may incorporate in its material selection opaque, transparent and translucent qualities and the materials may include a broad range of natural, synthetic, foil, metallic and precious metal materials that may be formed in a manner other than with the scoring and adhesive technique, most notably as a one piece, preformed, tooled, molded or heat sealed device containing a pocket to receive the corner of the page of a book, periodical, folio or other printed and non-printed matter.

Since the corner mark is triangular-shaped and duplicates in form the geometry of the page corner, it is free of protrusions, extensions or other discontinuities and presents a compact form that will not become bent, worn or damaged as it conforms to the peripheral boundaries of the book's pages. The corner mark therefore functions as a discreet finger-indexing device when it is positioned with respect to the top corner of the page of the book. The contact made with the pages of the book by the inside surface of the front panel 2 and the inside surface of the combination of the rear panel 3 and the adhesive panel 4 of the corner mark both by design and by friction, even with varying thicknesses of paper, are enough to keep it in place until it is manually removed by the user. These inner surfaces may also receive special treatment to enhance their ability to engage the corner of the page. It is therefore more readily stabile than a conventional bookmark which can slip out accidentally when a book is opened because the pressure on it has been eased.

Operation of the Corner Mark:

Corner mark 1, as shown in FIG. 1, conforms to the geometry of the top corner of the page of a book and because the corner mark contains a pocket into which is inserted the top corner of a page of a book, it remains fully engaged until the corner mark is removed manually by the user. As shown in FIG. 1, the lead edge 5 of the front panel 2 and the lead edge 6 of the combination of rear panel 3 and adhesive panel 4, are off-set to facilitate the ease of insertion of the top corner of the page of a book into the pocket of the corner mark. This, combined with the natural flexing and bowing of both the upper and lower panel of the corner mark, as such eliminates any need for prying open the pocket to insert the page corner.

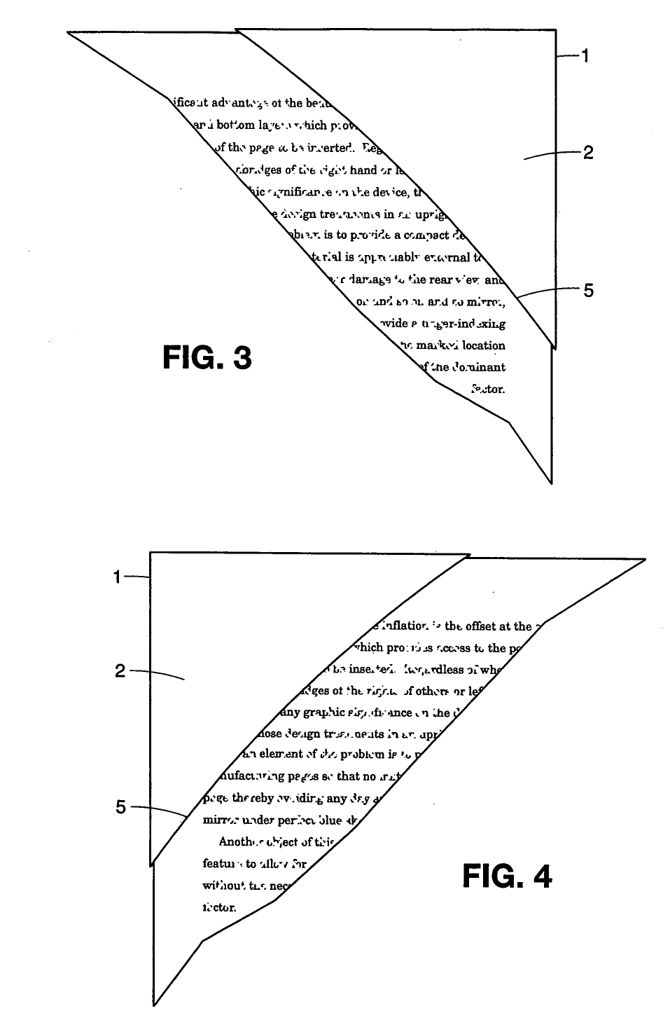

The corner mark therefore functions as a page corner sheath, as shown in FIGS. 3 and 4, always presenting a uniform contour and since it conforms to the geometry of the page corner, it is self-adjusting. The corner mark is pushed gently onto the page corner, coming to a natural stop when it occupies most of the pocket.

Also, since the corner mark is attached to the top corner of the page of a book and builds that corner out to a prescribed minimum degree, it functions effectively as a tactile sensory device and effectively permits the user to finger-index the device without acute visual inspection. The fingertips apply pressure as is necessary to effectively open the book to the desired page.

An index is “anything that serves as a guide . . . (to) facilitate reference . . . serves as an indicator” (The American Heritage Dictionary). The top and side peripheral edges of the corner mark are in accordance with the prominence needed to engage the fingertips and serves as a guide, an indicator.

The fingertip is the most sensitive part of the finger and with this fingertip one can manipulate the edge of the corner mark to open the the book to reveal the last page read, or the page saved, by the user. And the non-handedness characteristic of the corner mark permit its use on either the right hand or left hand page thereby identifying the exact page where the reader left off.

Utility:

The usefulness of a corner mark in accordance with the invention has distinct advantages over a conventional bookmark. It presents a more orderly and uniform appearance when there is an array of books that require the marking of place and when one view's them on a shelf. While a conventional bookmark is useful, the amount of material that extends from the book varies greatly and in the course of its life it can become bent, worn or damaged. It also can become completely submerged into the book pages and not show at all. A conventional bookmark does not identify whether the last page read, or saved, was the right hand page or the left hand page and the bookmark does not engage the page to prevent it from slipping out when the book is opened. And the uniqueness of the usefulness of a corner mark in accordance with the invention can be seen in its ability to allow finger-indexing to allow the user to find one's place which can be done with little or no visual inspection.

In order to facilitate the inserting of a page corner into the pocket of the corner mark, the overlap of the top and bottom layers has been offset so that the page corner is placed touching the bottom layer and then the corner mark is moved downwards and towards the spine of the book until it comes to a natural stop which happens when the page is fully inserted. This exemplifies another aspect of the use of the corner mark in that it finds it own stopping place by conforming to, and duplicating, the physical boundaries of the geometry of the page corner.

A corner mark in accordance with the invention is not only to be put to use with books but in many respects it is a superior place marking device in that it can used used effectively with any entity that has pages or sheets of material, of any thickness or surface, since it does not rely on the pressure of the closed book to hold it in place.

The description above and the accompanying figures are presented as examples of the present invention. The scope of the present invention is not limited by the exemplary embodiments. Other applications and variations of the present invention are possible to meet a particular application. For example, the shape of the corner mark does not have to be triangular, nor do the external sides need to be of the same length.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that any changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. A corner mark device whose function it is to identify the last page read the user, said corner mark device comprising:
A. A unified construction having, but not limited to, a triangular front and back layer of material having dimensions necessary to engage the corner of a a page onto which is is placed and conforms to; and
B. An offset in the overlap of the top and bottom layers of the device capable of allowing ease of entry of the corner of the page of a book; and
C. A use of material that has as its physical property the ability to flex and to bow to a minimal degree to employ a secondary characteristic for the ease of entry of the corner of the page of a book.

2. An corner mark device as set forth in claim 1 further including the ability to be engaged by either the right hand page or the left hand page of a book whereby the reader has identified the exact page to be saved.

3. An corner mark device as set forth in claim 2, further including the ability to be in an upright readable position of both the front and rear graphic treatment panels regardless of whether it is placed on a right hand page or a left hand page.

4. An corner mark device as set forth in claim 1, in which said material is capable of remaining in good condition by nature of its form being incorporated in the boundaries of the book.

5. An corner mark device as set forth in claim 1, in which the exposed minimum top and side edges formed by geometry of the device are capable of allowing finger-indexing to find one's place without acute visual inspection.

6. A corner mark device that is capable of finding its own stopping position when it is fully engaged by the corner of the page of the book indicating that it has occupied the maximum amount of space in the pocket.

7. A corner mark device as set forth in claim 1, in which the device is capable of remaining on the page corner even when the book is opened or the page of the book is turned and remains in place until manually removed by the user as it does not rely on the press of the two pages to hold it in place.

8. A corner mark device whose geometry and boundaries correspond substantially to those of the corner of the page of a book to which it is adapted to be engaged and conformed.

9. A corner mark device whose front and rear panels can be imprinted prominently, and economically, all the printable surfaces being on one side, with advertising, promotional material, descriptive messages, publisher identification, arresting graphic treatments, special and illuminated effects.
